(19) United States
(12) Patent Application Publication
(10) Pub. No.: US 2020/0195879 A1
(43) Pub. Date: Jun. 18, 2020

(54) Personal-use solar-powered satellite television receiver

(71) Applicant: Yaxin Shang, Guangzhou City (CN)

(72) Inventor: Yaxin Shang, Guangzhou City (CN)

(21) Appl. No.: 16/801,134

(22) Filed: Feb. 25, 2020

(30) Foreign Application Priority Data
Nov. 8, 2019 (CN) 2019110904429

(51) Int. Cl. H04N 5/63

(52) U.S. Cl. CPC H04N 5/63

(57) ABSTRACT

The invention discloses a solar-powered satellite television receiver for personal use, which includes a body. The body is provided with a rotating cavity. A right side wall of the rotating cavity is provided with a worm wheel cavity. The body is provided with two rotating blocks on the left and right sides symmetrically mounted with a solar power generation board, and the threaded motor drives the threaded shaft to rotate, thereby driving the threaded block to move back and forth, thereby driving the slider. The cleaning cotton is moved back and forth, and at the same time, the pumping motor supplies water to the cleaning cotton through the water pipe, thereby cleaning the solar panel. The present invention periodically cleans the solar power generation board through a cleaning device, which reduces dust. The impact of solar panels has improved the power generation efficiency of solar panels, so it is worth promoting.

### CROSS-REFERENCES TO RELATED APPLICATIONS

The present application claims priority from Chinese application No. 2019110904429 filed on Nov. 8, 2019 which is hereby incorporated by reference in its entirety.

### TECHNICAL FIELD

The present invention relates to the field of satellite equipment, in particular to a personal-use solar-powered satellite television receiver.

### BACKGROUND OF THE INVENTION

At present, with the development of society, satellite TV has become one of the public's choices other than Internet TV. However, the installation conditions for satellite TV are relatively high. First, the satellite receiver must be placed at a high point to adjust the angle before installation. Ensure that the received signal is stable. After that, the satellite receiver needs to be connected to the indoor power supply. However, because the satellite receiver is high and wonderful, the line is longer. The circuit may be short-circuited in a complicated environment, and the high point installation requires workers to transport it. The overall transportation is difficult, and some solar power satellite receivers currently available on the market have a smaller range of use. Due to the diversified environment, outdoor solar panels often reduce solar conversion rate and service life due to wind and sand blocking, so it is necessary to invent one. Personal-use solar-powered satellite TV receiver

### BRIEF SUMMARY OF THE INVENTION

The purpose of the present invention is to provide a solar-powered satellite television receiver for personal use, so as to solve the problems mentioned in the background art.

In order to achieve the above object, the present invention provides the following technical solution: A solar-powered satellite television receiver for personal use includes a body, wherein the body is provided with a rotating cavity, and a right side wall of the rotating cavity is provided with a worm wheel cavity. A debugging device for debugging the angle of the present invention is provided between the rotating cavity and the worm wheel cavity;

The fixed block can be installed on the upper side of the rotating cavity, and a main shaft rotatably connected to the bottom wall of the rotating cavity is rotatably connected in the fixed block. A receiver is fixed on the upper side of the main shaft, and the receiving A receiver battery for supplying power to the receiver is fixed between the receiver and the main shaft, a first pulley is fixed under the main shaft, and a worm shaft is rotatably connected to the upper and lower side walls of the right side of the worm wheel cavity. A second pulley corresponding to the first pulley is fixed on the lower side of the worm shaft, and a first belt is connected between the second pulley and the first pulley. A worm is fixed on the side, and a worm wheel shaft is rotatably connected to the front and rear side walls of the worm wheel cavity. The worm wheel axially extends rearwardly through the rear side wall of the worm wheel cavity and is rotatably connected to the rear side of the body. A handle is conveniently fixed on the rear side to control the rotation of the worm gear shaft, and a worm gear that is engaged with the worm is fixed on the worm gear shaft;

The bottom wall of the rotating cavity is provided with a transmission cavity, and the body is symmetrically provided with two rotating blocks on which the solar power generation board is installed. The transmission cavity and the rotating block are provided with adjustments according to the sun rising to the west Angle solar device, the rotating block is symmetrically provided with a sliding cavity up and down, the rotating cavity is symmetrically provided with two water storage cavities, and a solar panel can be cleaned between the water storage cavity and the sliding cavity Cleaning device.

Preferably, the solar device includes a transmission motor fixedly installed on the bottom wall of the transmission cavity, a controller for controlling the rotation frequency of the rotating block is fixed on the right side of the transmission motor, and the upper side of the transmission motor is power-connected A motor shaft is rotatably connected to the top wall of the transmission cavity. A pulley shaft is rotatably connected to the left and right sides of the transmission cavity symmetrically. A third pulley is fixed on the left and right sides of the motor shaft symmetrically. A second belt is connected between the two third pulleys, a fourth pulley is fixed on the right side of the pulley shaft and the motor shaft are symmetrically left and right, and the two fourth pulleys are connected There is a third belt. Each of the pulley shafts is fixed with a side wing battery installed on the rotating block. A motor wire is connected between the left side wing battery and the transmission motor and the controller. A receiver connecting line is connected between the side wing battery and the receiver battery.

Preferably, the cleaning device includes a water pipe fixedly installed on the top wall of each of the water storage chambers, and a pumping motor is provided between each of the water pipes and the bottom wall of the water storage chamber. An open cavity is provided on the side, and a threaded motor is fixed on the rear wall of each of the open cavity. A control wire is connected between each of the threaded motor and the controller, and a front side of each of the threaded motors is dynamically connected with A threaded shaft is rotatably connected to the front side wall of the opening cavity. Each of the threaded shafts is threadedly connected with a thread block. Each threaded block is fixed with a slider slidingly connected to the sliding cavity. A cleaning cotton for cleaning the solar power generation board is fixed on the slider, and each of the cleaning cotton is connected with a telescopic hose through the slider and the water pipe.

Preferably, a water inlet is provided on the top wall of each of the water storage chambers.

Preferably, the worm gear and worm mechanism composed of the worm shaft and the worm has a self-locking performance.

In summary, the present invention has the beneficial effects that the present invention effectively solves the problem of the long connection between the satellite television and the indoor power supply by using the solar power generation board for autonomous power supply, and prevents the leakage of electricity that may be caused by excessively long lines. The present invention is installed by sections, which is convenient for installation workers to place the present invention in places that are not easy to climb, and reduces the problem that the general satellite television receiver is picky about installation conditions. The present invention regularly cleans solar power generation panels through a cleaning device, reducing The impact of dust on solar panels has improved the power generation efficiency of solar panels, so it is worth promoting.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

FIG. 1 is a schematic front view of a solar cell-powered satellite television receiver for personal use according to the present invention;

FIG. 2 is a cross-sectional view in the direction A-A in FIG. 1 of the present invention;

FIG. 3 is a sectional view taken along the line B-B in FIG. 1 of the present invention;

FIG. 4 is a sectional view in the direction of C-C in FIG. 3 of the present invention

### DETAILED DESCRIPTION OF THE INVENTION

All features disclosed in this specification, or all disclosed methods or steps, except for mutually exclusive features and steps, can be combined in any way.

Any feature disclosed in this specification (including any additional claims, abstract, and drawings), unless specifically stated otherwise, may be replaced by other equivalent or similar purpose alternative features. That is, unless specifically stated, each feature is just one example of a series of equivalent or similar features.

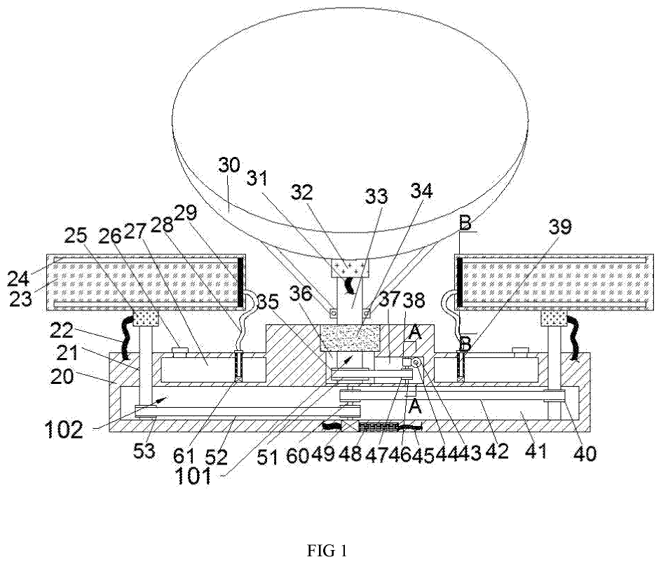

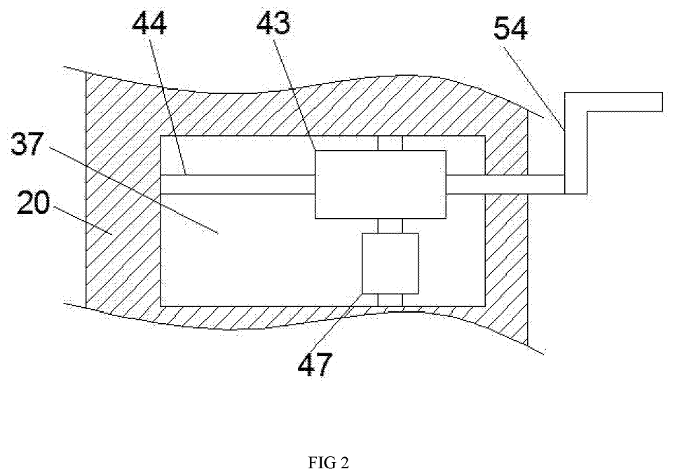

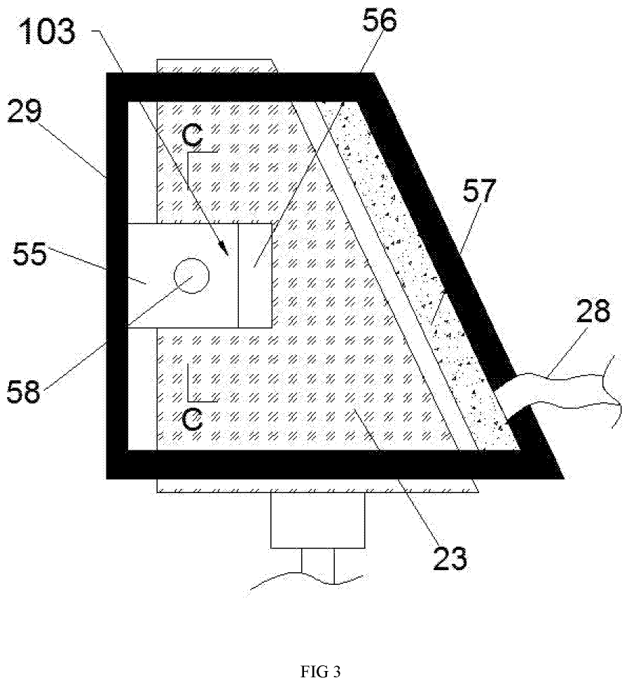

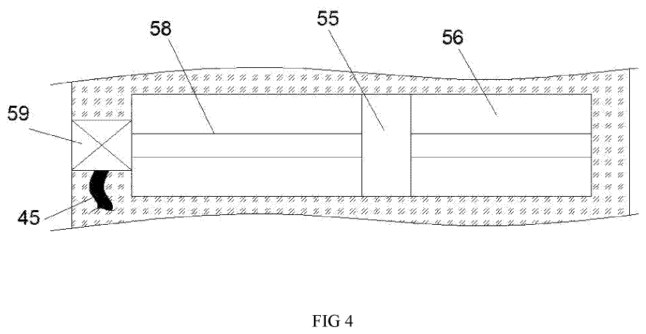

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself

Please refer to FIGS. 1-4. An embodiment of the present invention provides a solar-powered satellite television receiver for personal use, which includes a body 20. The body 20 is provided with a rotating cavity 36, and the rotating cavity 36 is right A worm gear cavity 37 is provided on the side wall, and a debugging device 101 for debugging the angle of the present invention is provided between the rotation cavity 36 and the worm gear cavity 37. The 101 includes a fixing block 34 that can be installed on the upper side of the rotation cavity 36. A main shaft 33 is rotatably connected to the bottom wall of the rotating cavity 36 in the fixing block 34. A receiver 30 is fixed on the upper side of the main shaft 33. The receiver 30 is fixedly connected to the main shaft 33. A receiver battery 32 is provided for supplying power to the receiver 30. A first pulley 35 is fixedly located below the main shaft 33. A worm shaft 46 is rotatably connected to the upper and lower side walls of the right side of the worm wheel cavity 37. A second pulley 47 corresponding to the first pulley 35 is fixed on the lower side of the worm shaft 46. A first belt 51 is connected between the second pulley 47 and the first pulley 35. A worm 38 is fixed on the upper side of the worm shaft 46, and a worm shaft 44 is rotatably connected to the front and rear side walls of the worm shaft 37. The worm shaft 44 The handle 54 extends rearwardly through the rear side wall of the worm wheel cavity 37 and is rotatably connected to the rear side of the body 20. The rear side of the worm wheel shaft 44 is fixed with a grip 54 for controlling the rotation of the worm wheel shaft 44. A worm wheel 43 which is engaged with the worm 38 is fixed on the worm wheel shaft 44. A transmission cavity 41 is provided on the bottom wall of the rotating cavity 36. The body 20 is symmetrically provided with two rotating blocks mounted with solar power generation panels. 23. A solar device 102 is provided between the transmission cavity 41 and the rotating block 23, and the angle can be adjusted according to the rising of the sun. The rotating block 23 is provided with a sliding cavity 24 symmetrically on the top and bottom, and the rotating cavity 36 is symmetrical on the left and right. Two water storage chambers 27 are provided, and a cleaning device 103 capable of cleaning the solar panel is provided between the water storage chamber 27 and the sliding chamber 24.

In addition, in one embodiment, the solar device includes a transmission motor 49 fixedly installed on the bottom wall of the transmission cavity 41, and a controller for controlling the rotation frequency of the rotating block 23 is fixed on the right side of the transmission motor 49. 48. A motor shaft 60 is rotatably connected to the top wall of the transmission cavity 41 on the upper side of the transmission motor 49. The upper and lower side walls of the transmission cavity 41 are symmetrically connected to the pulley shaft 21 on the left and right sides. A third pulley 53 is fixed on the left and right sides of the motor shaft 60 symmetrically. A second belt 52 is connected between the two third pulleys 53. The right pulley shaft 21 and the motor shaft 60 A fourth pulley 40 is symmetrically fixed on the upper and left sides, and a third belt 42 is connected between the two fourth pulleys 40. Each of the pulley shafts 21 is fixed with a rotating block 23 mounted on the rotating block 23. Side wing battery 25, a motor wire 22 is connected between the left side wing battery 25, the transmission motor 49, and the controller 48, and a right side wing battery 25 and the receiver battery 32 are connected to receive Device connection line 31, according to the sun rise and fall rules set by the controller 48 Controlling the transmission motor 49 to drive the motor shaft 60 to rotate, thereby driving the fourth pulley 40 and the third pulley 53 to rotate, thereby driving the rotating block 23 to rotate, so that the rotating block 23. Always face the sun, so as to absorb solar energy with maximum efficiency, so that the solar energy is converted into electric energy and stored in the wing battery 25. The wing battery 25 on the left powers the transmission motor 49 and the controller 48, and the right The side wing battery 25 supplies power to the receiver battery 32, thereby achieving internal balance, and no external power supply is required.

In addition, in one embodiment, the cleaning device 103 includes a water pipe 39 fixedly installed on a top wall of each of the water storage chambers 27, and each of the water pipes 39 and a bottom wall of the water storage chamber 27 are provided. The pumping motor 61 is provided with an opening cavity 56 on the rear side of each of the rotating blocks 23, and a screw motor 59 is fixed on the rear side of each of the opening cavity 56. Each of the screw motor 59 and the controller 48 Control wires 45 are connected between each other, and a threaded shaft 58 rotatably connected to the front side wall of the opening cavity 56 is connected to the front side of each of the threaded motors 59, and a threaded block 55 is threadedly connected to each of the threaded shafts 58. Each thread block 55 is fixed with a slider 29 slidably connected to the sliding cavity 24, and each of the sliders 29 is fixed with a cleaning cotton 57 for cleaning the solar power generation panel. The washing cotton 57 is connected with a telescopic hose 28 between the slider 29 and the water pipe 39. According to the time rule set by the controller 48, the threaded motor 59 and the pumping motor 61 are controlled to work. The threaded motor 59 drives the threaded shaft 58 to rotate, thereby driving the threaded block 55 to move back and forth. This drives the slider 29 and the cleaning cotton 57 to move back and forth. At the same time, the pumping motor 61 supplies water to the cleaning cotton 57 through the water pipe 39 and the telescopic hose 28, thereby Solar panels are cleaned.

In addition, in one embodiment, a water inlet 26 is provided on a top wall of each of the water storage chambers 27 to supply water to the water storage chambers 27. In addition, in one embodiment, the worm gear mechanism composed of the worm shaft 46 and the worm 38 has a self-locking performance, thereby effectively preventing the receiver 30 from rotating in a high wind state, thereby maintaining signal stability.

In the initial state, the receiver connecting line 31 and the body 20 are transported to the top of the building in batches and installed on the top of the building. The slider 29 is on the side close to the rotating cavity 36.

When it is necessary to install a satellite TV receiver, the receiver connecting line 31 and the body 20 are sent to the roof in batches for installation. First, the fixing block 34, the main shaft 33, and the receiver 30 are installed in the rotating cavity 36. It is fixed, so that the worm wheel shaft 44 and the worm wheel 43 are rotated by the rotation of the grip 54, thereby driving the worm 38 and the worm shaft 46 to rotate, thereby driving the first pulley 35 and the main shaft 33 to rotate, thus achieving the purpose of rotating the receiver 30 until the signal is received, the worm gear mechanism composed of the worm shaft 46 and the worm 38 has a self-locking performance, thereby effectively preventing the receiver 30 from rotating in a high wind state, thereby maintaining the stability of the signal. After installation, according to the law of the local sun Adjust the controller 48, and control the transmission motor 49 to drive the motor shaft 60 to rotate according to the rising and falling rules of the sun set by the controller 48, thereby driving the fourth pulley 40 and the third pulley 53 to rotate, thereby driving the rotating block 23 to rotate. As a result, the rotating block 23 always faces the sun, so as to absorb solar energy with maximum efficiency, and convert the solar energy into electrical energy and store it in the side battery 25, and the left side battery 25 The drive motor 49 and the controller 48 supply power, and the right-side wing battery 25 supplies power to the receiver battery 32, thereby achieving internal balance and eliminating the need for external power supply. At the same time, the controller 48 is set to clean the rotating block 23 According to the time rule set by the controller 48, the threaded motor 59 and the pumping motor 61 are controlled to work. The threaded motor 59 drives the threaded shaft 58 to rotate, thereby driving the threaded block 55 to move forward and backward, thereby driving the slider 29 and the cleaning cotton. 57 moves back and forth, and at the same time, the pumping motor 61 supplies water to the cleaning cotton 57 through the water pipe 39 and the telescopic hose 28, thereby cleaning the solar panel.

The beneficial effect of the present invention is that the present invention effectively solves the problem of the long connection between the satellite television and the indoor television by using the solar power generation board for autonomous power supply, and prevents the leakage phenomenon that may be caused by the excessively long line. It is convenient for installation workers to place the present invention in places that are not easy to climb, reducing the pickiness of general satellite TV receivers to installation conditions. The present invention regularly cleans solar power generation panels through a cleaning device, reducing dust and solar energy. The influence caused by the panel improves the power generation efficiency of the solar panel, so it is worth promoting.

The above are only specific embodiments of the invention, but the scope of protection of the invention is not limited to this. Any changes or replacements that are not thought through without creative work should be covered by the scope of protection of the invention. Therefore, the protection scope of the invention shall be subject to the protection scope defined by the claims.

1. A solar-powered satellite television receiver for personal use includes a body, which is characterized in that: a rotating cavity is provided in the body, and a worm gear cavity is provided on the right wall of the rotating cavity, and the rotating cavity and the worm gear cavity A debugging device for debugging the angle of the present invention is provided between the two; the fixing block can be installed on the upper side of the rotating cavity, and a main shaft rotatably connected to the bottom wall of the rotating cavity is rotatably connected in the fixing block. A receiver is fixed on the upper side of the main shaft, and a receiver battery for supplying power to the receiver is fixed between the receiver and the main shaft. A first belt wheel and the worm gear are fixed on the lower side of the main shaft. A worm shaft is rotatably connected to the upper and lower side walls of the cavity, and a second pulley corresponding to the first pulley is fixed on the lower side of the worm shaft. A first belt is connected in between, a worm is fixed on the upper side of the worm shaft, a worm shaft is rotatably connected to the front and rear side walls of the worm wheel cavity, and the worm wheel axially extends through the rear side wall of the worm wheel cavity and communicates with the rear side of the body is rotationally connected. A grip is conveniently fixed on the side for controlling the rotation of the worm gear shaft, and a worm gear that is engaged with the worm is fixed on the worm gear shaft; a transmission cavity is provided on the bottom wall of the rotating cavity, and the body is symmetrical with left and right peripherals There are two rotating blocks on which solar power generation boards are installed, and a solar device capable of adjusting the angle according to the rising of the sun and the western setting is provided between the transmission cavity and the rotating block. The rotating cavity is provided with two water storage chambers symmetrically to the left and right, and a cleaning device capable of cleaning the solar panel is provided between the water storage chamber and the sliding chamber.

2. The solar-powered satellite television receiver for private use according to claim 1, wherein the solar device comprises a transmission motor fixedly installed on the bottom wall of the transmission cavity, and the right side of the transmission motor is fixed. There is a controller for controlling the rotation frequency of the rotating block, a motor shaft rotatably connected to the top wall of the transmission cavity is connected to the upper side of the transmission motor, and a pulley shaft is rotatably connected to the upper and lower side walls of the transmission cavity. A third pulley is fixed symmetrically on the left side of the pulley shaft and the motor shaft, a second belt is connected between the two third pulleys, and the right side of the pulley shaft is connected to the motor shaft. A fourth pulley is fixedly fixed to the left and right, and a third belt is connected between the two fourth pulleys. Each of the pulley shafts is fixed with a side wing battery mounted on the rotating block. A motor wire is connected between the side wing battery, the transmission motor and the controller, and a receiver connection line is connected between the right side wing battery and the receiver battery.

3. The solar-powered satellite television receiver for private use according to claim 1, wherein the cleaning device comprises a water pipe fixedly installed on a top wall of each of the water storage chambers, and each of the water pipes and A pumping motor is provided between the bottom wall of the water storage cavity, an opening cavity is provided on the rear side of each of the rotating blocks, and a threaded motor is fixed on the rear side wall of each of the opening cavities. Control wires are connected between the controllers, the front side of each of the threaded motors is dynamically connected with a threaded shaft that is rotationally connected to the front side wall of the opening cavity, and each of the threaded shafts is threaded with a threaded block, each A sliding block that is slidably connected to the sliding cavity is fixed on the thread block. Each of the sliding blocks is fixed with a cleaning cotton for cleaning the solar power generation board, and each of the cleaning cottons passes through the sliding block. A telescopic hose is connected to the water pipe.

4. The solar-powered satellite television receiver for private use according to claim 1, wherein a water inlet is provided on a top wall of each of the water storage chambers.

5. The solar-powered satellite television receiver for private use according to claim 1, characterized in that the worm gear mechanism composed of the worm shaft and the worm has self-locking performance.
